(19) United States
(12) Patent Application Publication
(10) Pub. No.: US 2024/0236858 A1
(43) Pub. Date: Jul. 11, 2024

(54) METHODS, DEVICES, AND SYSTEMS FOR TRANSMITTING AND RECEIVING SIGNAL FOR POWER MANAGEMENT

(71) Applicant: ZTE Corporation, Shenzhen (CN)

(72) Inventors: Xuan MA, Shenzhen (CN); Mengzhu CHEN, Shenzhen (CN); Focai PENG, Shenzhen (CN); Jun XU, Shenzhen (CN)

(73) Assignee: ZTE Corporation, Shenzhen (CN)

(21) Appl. No.: 18/617,840

(22) Filed: Mar. 27, 2024

Related U.S. Application Data
(63) Continuation of application No. PCT/CN2021/131659, filed on Nov. 19, 2021.

(51) Int. Cl. H04W 52/02; H04L 5/00; H04W 24/10; H04W 68/02

(52) U.S. Cl. CPC H04W 52/0235; H04L 5/0051; H04W 24/10; H04W 68/02

(57) ABSTRACT

The present disclosure describes methods, system, and devices for transmitting and receiving signal for power management. One method includes transmitting, by a user equipment (UE) to a base station, a message comprising information. Another method includes receiving, by a base station from a user equipment (UE), a message comprising information; and performing, by the base station, a power state related operation.

### TECHNICAL FIELD

The present disclosure is directed generally to wireless communications. Particularly, the present disclosure relates to methods, devices, and systems for transmitting and receiving signal for power management.

### BACKGROUND

Wireless communication technologies are moving the world toward an increasingly connected and networked society. High-speed and low-latency wireless communications rely on efficient network resource management and allocation among one or more user equipment and one or more wireless access network nodes (including but not limited to base stations). A new generation network is expected to provide high speed, low latency and ultra-reliable communication capabilities and fulfill the requirements from different industries and users.

With the rapid evolution of cellular mobile communication systems, the power consumption of the new generation wireless base station has increased significantly. For example, compared with 4G base stations, the power consumption of 5G base stations is about a few times higher than that of 4G base stations due to the increased number of transmission/receive antennas, frequency band, etc. Improving the network energy efficiency is important to build a green and sustainable wireless communication system. However, some power saving schemes may have a number of problems/issues, for example, causing a large delay and affecting the user experience.

The present disclosure describes various embodiments for transmitting and receiving signal for power management, addressing at least one of the problems/issues discussed above. The various embodiments in the present disclosure may saving power and avoid affecting user experience, improving a technology field in the wireless communication.

### SUMMARY

This document relates to methods, systems, and devices for wireless communication, and more specifically, for transmitting and receiving signal for power management.

In one embodiment, the present disclosure describes a method for wireless communication. The method includes transmitting, by a user equipment (UE) to a base station, a reference signal or a channel, wherein the initial reference signal or the channel is used for measurement or used to carry first information.

In another embodiment, the present disclosure describes a method for wireless communication. The method includes receiving, by a base station from a user equipment (UE), an initial reference signal or a channel, wherein the initial reference signal or the channel is used for measurement or used to carry first information; and performing, by the base station, at least one of a measurement operation or a power state related operation.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of a method for wireless communication.

FIG. 4B shows a flow diagram of a method for wireless communication.

FIG. 5A shows an example of an exemplary embodiment for wireless communication.

FIG. 5B shows an example of an exemplary embodiment for wireless communication.

FIG. 6 shows an example of an exemplary embodiment for wireless communication.

FIG. 7A shows an example of an exemplary embodiment for wireless communication.

FIG. 7B shows an example of an exemplary embodiment for wireless communication.

FIG. 8 shows an example of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for transmitting and receiving signal for power management.

New generation (NG) mobile communication system are moving the world toward an increasingly connected and networked society. High-speed and low-latency wireless communications rely on efficient network resource management and allocation among one or more user equipment and one or more wireless access network nodes (including but not limited to wireless base stations). A new generation network is expected to provide high speed, low latency and ultra-reliable communication capabilities and fulfill the requirements from different industries and users.

With the rapid evolution of cellular mobile communication systems, a wireless base station or wireless network node is using more and more power. For example, compared with 4G base stations, the power consumption of 5G base stations is 3-4 times that of 4G base stations due to the increased number of transmission/receive antennas, frequency band, etc. Improving the network energy efficiency is important to build a green and sustainable wireless communication system.

To obtain the power saving gain, some implementations may configure that the network may de-active/turn-off some components (e.g., cell, carrier, band, etc.) to enter into a sleep state or a less-power-consumed state. However, the semi-static wake-up scheme may cause a large delay and affect the user experience. The present disclosure describes various methods and devices for transmitting and receiving signal for power management, providing a more flexible wake-up mechanism and reduce impact on user experience.

In general, the power consumption of a communication system may be split into two parts: the dynamic part and the static part. In general, the dynamic part may be only consumed when data transmission/reception is ongoing, for example the power consumption caused by radio frequency (RF) unit, digital to analog converter (DAC), power amplifier (PA), and/or the antennas. The static part may be consumed all the time, even when the data transmission/reception is not on-going, for example the basic digital circuit access devices for waking up the equipment in sleep modes.

The power consumption of the static part accounts for a small part of the power consumption of the entire network, and may be difficult to be effectively reduced. The network energy saving solution may turn its focus on the dynamic power consumption.

Switch to sleep mode or turn off some RF components when they are not needed are effective methods to reduce network power consumption. For example, if there is no UE access, the carrier may be deactivated. When the traffic load is low, the number of Tx/Rx antennas may be reduced. However, there are some problems with this energy saving method. First, there are some always-on common signals and necessary transmissions in new radio (NR), for example the synchronization signal block (SSB), system information block (SIB1), paging, and physical random access channel (PRACH) reception. Therefore, the network may not easily enter into the low power consumption state, e.g., the sleep mode. Secondly, even if the devices can enter sleep states, it is a problem to wake up the devices. If semi-static configuration is used, the devices may be awakened only after sleeping for a period of time. If there is service requirement while the device is in sleeping states, the service requirement may not be met because of the caused delay, so as to affect user experience.

In various embodiments, the network may be able to enter the low power consumption state as long as possible to reduce power consumption of communication systems; a more dynamic wake-up mechanism may be introduced to meet the flexible service requirements and minimize the impact on user experience; and/or one or more UE may be involved in this procedure to achieve better results.

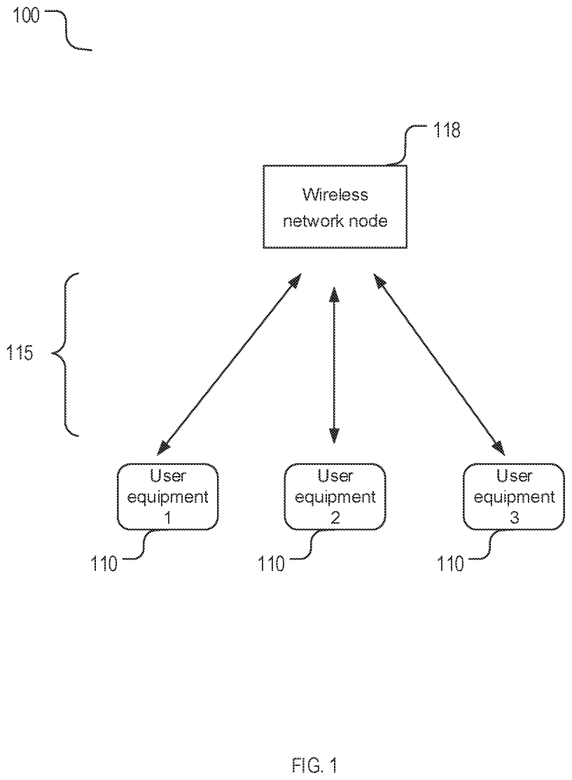

FIG. 1 shows a wireless communication system 100 including a wireless network node 118 and one or more user equipment (UE) 110. The wireless network node may include a network base station, which may be a nodeB (NB, e.g., a gNB, a eNB) in a mobile telecommunications context. Each of the UE may wirelessly communicate with the wireless network node via one or more radio channels 115. For example, a first UE 110 may wirelessly communicate with a wireless network node 118 via a channel including a plurality of radio channels during a certain period of time. The network base station 118 may send high layer signalling to the UE 110. The high layer signalling may include configuration information for communication between the UE and the base station. In one implementation, the high layer signalling may include a radio resource control (RRC) message.

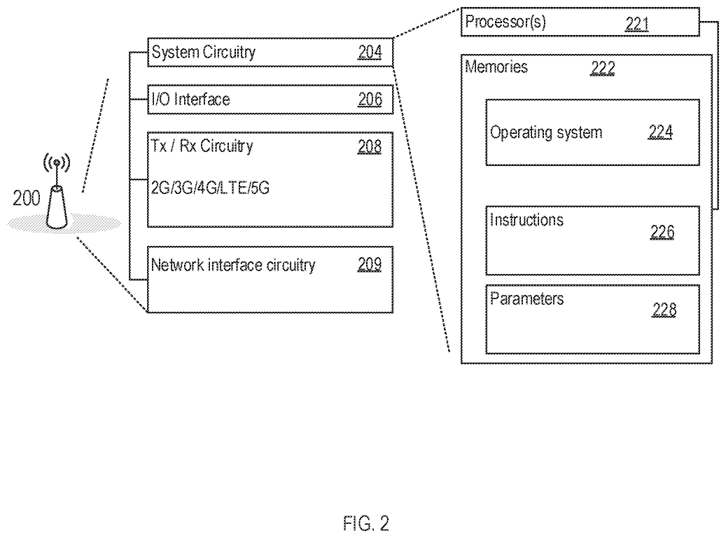

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

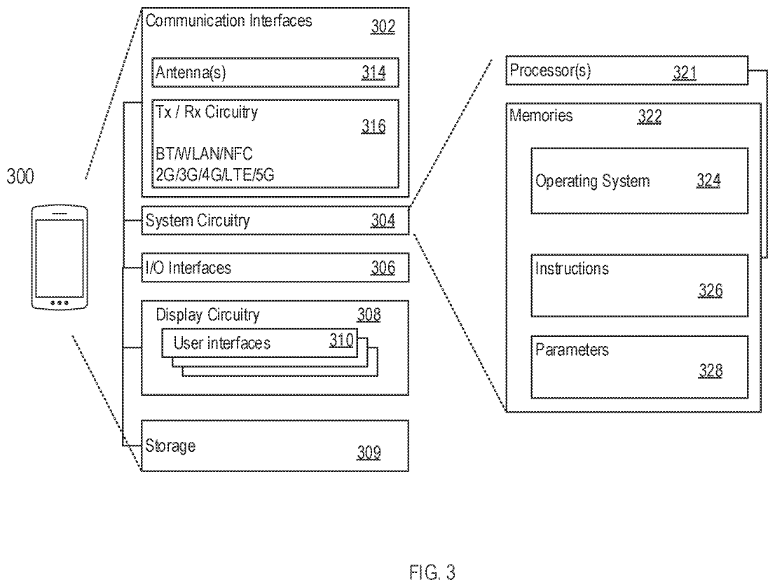

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, and any further generation wireless communication standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

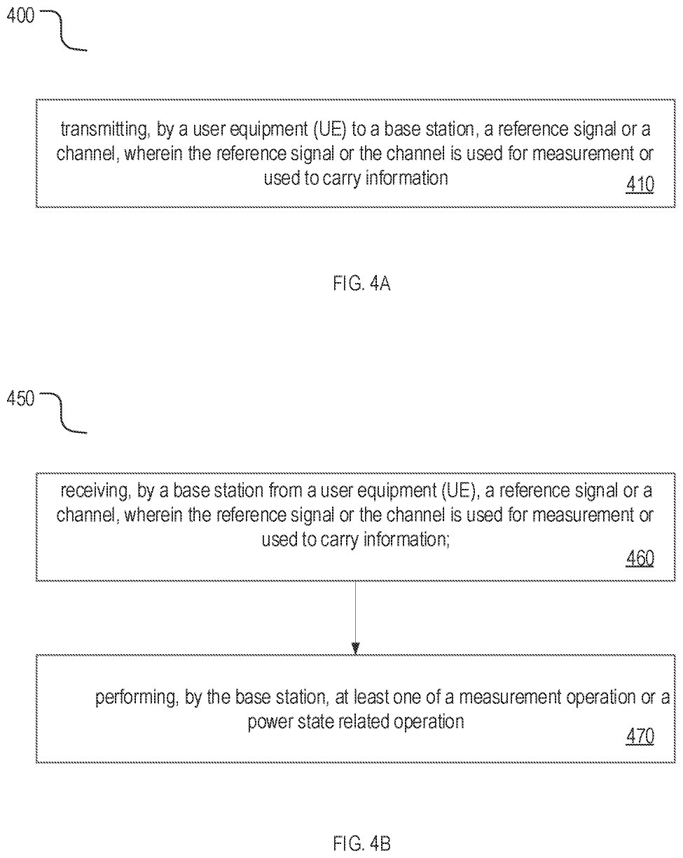

Referring to FIG. 4A, the present disclosure describes various embodiments of a method 400 for wireless communication. The method 400 may include step 410, transmitting, by a user equipment (UE) to a base station, a reference signal or a channel, wherein the reference signal or the channel is used for measurement or used to carry information.

In some implementations, the reference signal or the channel is used for measurement, wherein the measurement comprise at least one of the following, the mobility measurement; the radio resource management (RRM); the coverage information; the channel or interference measurement; acquire the speed of UE; acquire the quality of reference signal or channel, wherein the quality of reference signal comprises at least one of the RSRP (reference signal received power), RSRQ (reference signal received quality), RSSI (reference signal state information), SINR (signal-to-noise and interference ratio), the L1-RSRP and L1-SINR of the reference signal or channel.

In some implementations, the information comprises at least one of the following: a indication which is used to indicate a power state; a power state transition indication; a wake up indication; a set of measurement results; or assistance information.

In some other implementations, the power state is one of a set of power states, wherein the power state is determined by at least one of the following: a higher layer configuration; or a UE capability.

In some implementations, the power state comprises a first power state, wherein the first power state comprises at least one of the following: turning on at least one of the elements; turning on at least one of the components of at least one of elements; increasing transmission of a given reference signal; increasing transmission of a pre-determined data; increasing a configuration of at least one of elements; or keeping an element on current state.

In some other implementations, the power state comprise a second power state, wherein the second power state comprises at least one of the following: at least one of the elements being at a power-off state, wherein the power-off state comprises one of a turned-off state or a de-activated state; at least one of components of at least one of elements being at the power-off state; a relaxed transmission of a given reference signal; a relaxed reception of a given reference signal; a relaxed transmission or reception of a pre-determined data; a relaxed reception of a pre-determined data; a relaxed configuration of at least one of elements; a lower power consumption state than a state with a highest configuration of the element; or a lower power consumption state than a state with current configuration of the element.

In some other implementations, at least one of the first power state or the second power state is determined by at least one of the following: a transmission periodicity of a pre-determined reference signal or data; a reception periodicity of a pre-determined reference signal or data; a number of an element.

In some other implementations, the element comprises at least one of the following: a cell, a frequency layer, a band, a carrier, a transmission and receive point (TRP), a beam, a transmission configuration indication (TCI) state, an antenna, an antenna port, a multiple input multiple output (MIMO) layer, a rank, an antenna panel, a reference signal, or a reference resource.

In some other implementations, the given reference signal comprises at least one of the following: a synchronization signal block (SSB), a discovery burst, a channel state information reference signal (CSI-RS), a sounding reference signal (SRS), or a positioning reference signal (PRS).

In some other implementations, the pre-determined data comprises at least one of the following: a system information block (SIB), a downlink control information (DCI) that schedules a SIB, a paging message, a paging DCI, a DCI format 2_6, a DCI format 2_7 and a broadcast DCI format.

In some other implementations, the relaxed transmission of the given reference signal comprises at least one of the following: relaxing a transmission cycle of the given reference signal; relaxing a transmission interval of the given reference signal; reducing transmission beams of the given reference signal; stopping the transmission of the given reference signal; or transmitting the given reference signal with a first number of beams.

In some embodiments, the relaxed transmission cycle or interval of the given reference signal includes transmitting the given reference signal with a transmission cycle or interval of at least one of 40*a*2\hat{ }(n) millisecond, where a is a positive value, n is a non-negative integer. In this embodiment, the given reference signal includes at least one of SSB, or periodic CSI-RS configured by system information. In this example, the transmission periodicity of SSB or periodic CSI-RS is relaxed compared with a periodicity of 20 millisecond in the legacy implementation, which is beneficial to network energy saving.

In some other implementations, the relaxed reception of the given reference signal comprises at least one of the following: relaxing a reception cycle of the given reference signal; relaxing a reception interval of the given reference signal; reducing reception beams of the given reference signal; stopping the reception of the given reference signal; or receiving the given reference signal with a second number of beams.

In some other implementations, the relaxed transmission of the pre-determined data comprises at least one of the following: relaxing a transmission cycle of the pre-determined data; relaxing a transmission interval of the pre-determined data; stopping the transmission of the pre-determined data; reducing transmission beams of the pre-determined data; or transmitting the pre-determined data with a third number of beams.

In some other implementations, the relaxed reception of the pre-determined data comprises at least one of the following: relaxing a reception cycle of the pre-determined data; relaxing a reception interval of the pre-determined data; stopping the reception of the pre-determined data; reducing reception beams of the pre-determined data; or receiving the pre-determined data with a fourth number of beams.

In some embodiments, the relaxed transmission cycle or interval of the pre-determined data includes transmitting the pre-determined reference signal with a transmission cycle or interval of at least one of 160*b*2\hat{ }(m) millisecond, where b is a positive value, m is a positive integer. In this embodiment, the pre-determined data includes at least one of SIB 1. In this example, the transmission periodicity of SIB 1 is relaxed compared with a periodicity of 160 millisecond in the legacy implementation, which is beneficial to network energy saving.

In some other implementations, the relaxed configuration of at least one of the elements comprises at least one of the following: reducing a number of at least one of the following: active cells, frequency layers, bands, carriers, TRPs, beams, TCI states, antennas, antenna ports, MIMO layers, ranks, antenna panels, reference signals, or reference resources; reducing a number of ports of reference signals; configuring the element with a fifth number; configuring the element with a sixth number of ports; or configuring a cell with at least one pre-set DRX parameter.

In some other implementations, the increasing transmission of the given reference signal comprises at least one of the following: increasing a transmission cycle of the given reference signal; increasing a transmission interval of the given reference signal; increasing transmission beams of the given reference signal; transmitting the given reference signal with a seventh number of beams; or transmitting the given reference signal with a eighth cycle.

In some other implementations, the increasing reception of the given reference signal comprises at least one of the following: increasing a reception cycle of the given reference signal; increasing a reception interval of the given reference signal; increasing reception beams of the given reference signal; receiving the given reference signal with a ninth number of beams; or receiving the given reference signal with a tenth cycle.

In some other implementations, the increasing transmission of the pre-determined data comprises at least one of the following: increasing a transmission period of the pre-determined data; increasing a transmission interval of the pre-determined data; increasing transmission beams of the pre-determined data; transmitting the pre-determined data with a eleventh number of beams; or transmitting the pre-determined data with a twelfth cycle.

In some other implementations, the increasing reception of the pre-determined data comprises at least one of the following: increasing a reception period of the pre-determined data; increasing a reception interval of the pre-determined data; increasing reception beams of the pre-determined data; receiving the pre-determined data with a thirteenth number of beams; or receiving the pre-determined data with a fourteenth cycle.

In some other implementations, the set of measurement results is related to at least one of the following: UE mobility information; radio resource management (RRM) measurement results; coverage information; channel measurement results; or channel interference measurement results.

In some other implementations, the assistance information comprises at least one of the following: UE mobility information, UE capability, UE requirement for a delay, a UE-preferred bandwidth, or a service scenario of UE.

In some other implementations, the transmission of the reference signal or the channel is determined by at least one of the following: a higher layer configuration; a UE capability; an SCS; or a frequency range.

In some other implementations, the transmission of the reference signal or the channel is determined by at least one of a start point, a duration, a end position, or a periodicity.

In some other implementations, the transmission of the reference signal or the channel is determined by a first window, wherein: the first window is determined by a start position and a duration; or the first window is determined by the start position and an end position.

In some other implementations, at least one of the start position or the end position is defined in relative to at least one of the following: an SSB; a secondary synchronization signal (SSS); a primary synchronization signal (PSS); a tracking reference signal (TRS); a paging occasion (PO); a paging frame (PF), a discontinuous reception (DRX) ON duration; a DCI format 2_7, a DCI format 2_6, or a broadcast DCI format.

In some other implementations, the transmission of the reference signal or the channel is determined by a preferred configuration by the UE, wherein the preferred configuration by the UE comprises at least one of the following: accessing to a cell, a configuration of at least one of elements, a number of ports of the transmission of the pre-determined data, a number of ports of the transmission of the given reference signals, a number of beams of the transmission of the pre-determined data, a number of beams of the transmission of the given reference signals, increasing a number of at least one of elements, increasing a number of ports of the transmission of the pre-determined data, increasing a number of ports of the transmission of the given reference signals, increasing a number of beams of the transmission of the pre-determined data, increasing a number of beams of the transmission of the given reference signals, data to be transmitted, or smaller transmission delay.

In some other implementations, the increasing the configuration of at least one of elements comprises at least one of the following: increasing a number of at least one of the following: active cells, frequency layers, bands, carriers, TRPs, beams, TCI states, antennas, antenna ports, MIMO layers, ranks, antenna panels, reference signals, or reference resources; increasing a number of ports of the given reference signals; increasing the element with a configured number; or increasing the element with a pre-determined number of ports.

In some other implementations, the transmission of the reference signal or the channel comprising the information is determined by a timer.

In some other implementations, the transmission of the reference signal or the channel comprising the transmission of the information is determined by a timer.

In some other implementations, the timer is determined by a higher layer signaling.

In some other implementations, the timer is one of a permissive timer or a prohibit timer, wherein: the UE transmits the message when the permissive timer is running; or the UE transmits the message after the prohibit timer expires.

In some other implementations, a number of times for the UE transmitting the reference signal or the channel does not exceed a maximum transmission time.

In some other implementations, a transmission resource in time domain of the reference signal or the channel is associated with a transmitted times of the reference signal or the channel.

In some other implementations, the transmitting the reference signal or the channel in a frequency domain is determined by at least one of the following: a higher layer signaling; a start position in a frequency domain; an end position in a frequency domain; a number of resource blocks (RBs); an SSB; a control resource set (CORSET) 0; an active bandwidth part (BWP); an initial uplink (UL) BWP; a transmission resource in the frequency domain of the message being associated with transmitted times of the message.

In some other implementations, the reference signal comprising at least one of the following: a SRS based signal; a Zadoff-chu (ZC) sequence based signal; or a physical random access channel (PRACH) preamble based signal.

In some other implementations, the channel comprising at least one of the following: a Message A based channel; a physical uplink control channel (PUCCH); a physical uplink shared channel (PUSCH); or a medium access control (MAC) control element (CE).

In some other implementations, the information comprised in the reference signal or the channel is associated with the at least one of the following: a sequence generation comprising at least one of a cycling shift, or a sequence initialization; a format; a time domain resource allocation of the message; a frequency domain resource allocation of the message; an ID associated with the message; an ID associated with the UE; a group ID associated with the UE or a group ID associated with the message.

In some other implementations, the information carried in the reference signal or the channel comprises a bit for indicating a state transition for the base station, wherein: the bit being a first value indicates the first power state; or the bit being a second value indicates the second power state.

In some other implementations, the information carried in the reference signal or the channel comprises n bits for indicating a state transition for the base station, n being an integer larger than one, wherein: the n bits being a value of N−1 indicates the base station to switch from a present power state to a N-th power state.

In some other implementations, the information comprises n bits for indicating a state transition for the base station, n being an integer no smaller than one.

In some embodiments, at least one of the states is determined by at least one of the following: a transmission periodicity of the given reference signal or the pre-determined data; a reception periodicity of the given reference signal or the pre-determined data; a number of the element.

In some other implementations, a wake-up indication indicates the second power state.

In some other implementations, a wake-up indication indicates a third power state.

In some other implementations, at least one of the following differences exists between the third state and the first or second state: a transmission periodicity of the given reference signal or the pre-determined data; a reception periodicity of the given reference signal or the pre-determined data; a number of the element, the configuration of at least one of the configuration.

In some other implementations, a application delay after transmitting the message, the UE determines the information as being valid, wherein the application delay is determined by at least one of the following: a higher layer signaling; UE capability; a frequency range; indication information by the UE; a pre-set value; or a configured value set.

Referring to FIG. 4B, the present disclosure describes various embodiments of a method 450 for wireless communication. The method 450 may include a portion or all of the following steps: step 460, receiving, by a base station from a user equipment (UE), a reference signal or a channel, wherein the reference signal or the channel is used for measurement or used to carry information; and/or step 470, performing, by the base station, at least one of a measurement operation or a power state related operation.

In some implementations, the information carried by the reference signal or the channel comprises at least one of the following: a indication which is used to indicate a power state; a power state transition indication; a wake up indication; a set of measurement results; or assistance information.

In some other implementations, the measurement operation comprise at least one of the following: the mobility measurement; the radio resource management (RRM); the coverage information measurement; the channel or interference measurement; acquire the speed of UE; acquire the quality of reference signal or channel, wherein the quality of reference signal comprises at least one of the RSRP (reference signal received power), RSRQ (reference signal received quality), RSSI (reference signal state information), SINR (signal-to-noise and interference ratio), the L1-RSRP and L1-SINR of the reference signal or channel.

In some other implementations, the power state related operation comprises at least one of the following: switching to the first power state; switching to the second power state; switching to a N-th power state; keeping on the first power state; keeping on the second power state; or keeping on the N-th power state.

In some other implementations, the base station switches to or keeps on the second power state according to at least one of the following: receiving multiple indications, for example X indications, from at least one UE to indicate the second power state, X being a positive integer and a number of UEs in a same power consumption state; receiving a first assistance information; a number of UEs in one cell being less than a threshold; or configuring at least one of a period, a timer, or a duration.

In some other implementations, the first assistance information related to the base station switching to the second power state satisfies at least one of the following: a mobility speed of the UE being lower than a threshold; a current service of the UE being insensitive to a delay; data to be transmitted for the UE in following periods being small; the UE expecting to enter a low power consumption state; or the UE obtaining another message from another cell.

In some other implementations, the base station switches to or keeps on the first power state according to at least one of the following: receiving X indication from at least one UE to indicate the first power state, X being a positive integer and a number of UEs in a same power consumption state; receiving a second assistance information; a number of UEs in one cell being large than a threshold; a traffic type currently transmitted; a UE capability; or configuring at least one of a period, a timer, or a duration.

In some other implementations, the second assistance information satisfies at least one of the following: a mobility speed of the UE being larger than a threshold; a current service of the UE being sensitive to a delay; data to be transmitted for the UE in following periods being large; or the UE being unable to obtain other message from another cell.

In some other implementations, the information in the message corresponds to the base station switching between a first power state and a second power state.

In various embodiment, a UE may transmit a data and/or reference signal to a base station (gNB). The reference signal and/or the channel is used for measurement or use to carry information. The present disclosure describes below examples for various embodiments. The below examples are for illustration purpose, and do not limit the scopes of the various embodiments.

### Content/Functionalities in the Information

In some embodiments, the information carried by the data and/or reference signal includes at least one of the following items.

For one item, the information carried by the data and/or reference signal may include State (mode) indication for gNB or base station. In some embodiments, the power state includes a set of power states, different power states in the power state set have different configurations. The state indication can indicate one of the power states, for example, the state indication can indicate the switching between power saving states and other states.

In some implementations, the power saving state, and other states is determined by at least one of the following: a higher layer configuration or UE capability.

Regarding the higher layer configuration, the higher layer configuration is associated with an element. In some embodiments, the element includes at least one of the following elements: cell, frequency layer, band, carrier, transmission and receive point (TRP), beam, transmission configuration indication (TCI) state, antenna, antenna port, MIMO layer, rank, antenna panel, reference signal, or reference resource. For example, the state of the gNB or base station with less than two cells activated is called power saving state, otherwise is called the other state or non-power saving state. Similarly, the state of the gNB or base station with different configurations about the elements listed above can be classified as power saving state or other state (e.g., non-power saving state).

In some implementations, the one or more element is used for transmission and/or reception.

In some other implementations, the power saving state is a fixed state with some fixed configuration. For example, the minimum cycle of reference signal transmission in power saving state is equal to D, wherein D is a fixed value, e.g., D=80 millisecond (ms), the antenna port in power saving state is less than A, wherein A is a fixed value, e.g., A=2. In some embodiments, the power saving state is a relative state. For example, the power saving state can be a configuration, a working mode, or a configured state. For example, the power saving state is a relative lower power consumption state. The power saving state is relative to the highest configuration or current configuration of the element. For example, the elements have three states, state1, state2, and state3. Compared with state 1, state 2 and state 3 are both power saving states. Compared with state 2, state 3 is power saving state.

Similarly, the other states may be defined relative to the power saving state. In some example, the power state includes at least one of the configurations, such as, the bandwidth, the number of antennas, the MIMO layers.

Regarding UE capability, the state corresponding to the configuration with the lowest power consumption supported by the UE capability is power saving state.

In some other implementations, the power saving state includes at least one of the following.

The power saving state may include one state wherein the element is turned off or de-activated;

The power saving state may include another state wherein the component of the element is turned off or de-activated;

The power saving state may include an idle state. In some embodiments, the idle state includes at least one of the characteristics: transmit system information (SI) and receive SI request (if configured); transmit DCI scramble with P-RNTI; the DCI can carry short message and/or paging scheduling information; transmit paging message; or transmit synchronization signal block (SSB).

The power saving state may include an inactive state. In some embodiments, the inactive state include at least one of the characteristics: transmit system information (SI) and receive SI request (if configured); transmit DCI scramble with P-RNTI; the DCI can carried short message and/or paging scheduling information; transmit paging message; transmit synchronization signal block(SSB); or store the UE Inactive access stratum (AS) context.

The power saving state may include a dormancy state. In some embodiments, the dormancy state includes at least one of the characteristics: not receive SRS (Sounding Reference Signal); not receive PUSCH (Physical Uplink Shared channel); not receive PRACH (Physical Random Access Control Channel); not transmit the PDCCH (Physical Downlink Control Channel); not receive PUCCH (Physical Uplink Control Channel); not transmit CSI-RS (Channel State Information reference signal).

The power saving state may include another state wherein the transmission or reception of a pre-determined reference signal is relaxed. For example, the pre-determined reference signal includes at least one of SSB, discovery burst, CSI-RS, SRS, positioning RS. In some embodiment, relaxing the transmission or reception of the pre-determined reference signal includes at least one of the following: relaxing the transmission or reception cycle or transmission interval of the pre-determined reference signal, transmitting or receiving the pre-determined reference signal with a pre-determined cycle, or transmitting or receiving the pre-determined reference signal with an indicated cycle; reducing the transmission or reception beams of the pre-determined reference signal; stopping the transmission or reception of some pre-determined reference signal (for example, no SSB is transmitted, and only the RS used for Sync and cell measurement are transmitted); or transmitting or receiving the pre-determined reference signal with a pre-determined number of beams. In some embodiment, the determined number of beams is one beam. In some embodiment, the determined number of beams is associated with frequency range (for example, FR1, FR2).

In some embodiments, the pre-determined cycle includes 80 (or 40, 60, etc.) milliseconds. In this embodiment, the a power saving state is indicated implies transmitting SSB with default cycle, i.e., 80 milliseconds.

In some embodiments, the indicated cycle is associated or indicated by the state indication. For example, the indicated cycle is comprised in the same data packet with state indication. For example, the indication cycle is associated with at least one of the time, frequency, and spatial resource of the state indication.

The power saving state may include another state wherein the transmission or reception of a pre-determined data is relaxed. For example, the pre-determined data includes at least one of the system information block (SIB), for example the SIB1, DCI that schedules system information block, paging message, paging DCI, DCI format 2_7, DCI format 2_6 or broadcast DCI formats. In some embodiment, DCI format 2_7 (also termed as paging early indication, PEI) is a DCI transmitted before PO includes indication of whether there is a paging message to be received. In some embodiment, relaxing the transmission or reception of the pre-determined data includes at least one of the following: relaxing the transmission/reception cycle or transmission/reception interval of the pre-determined data; stopping the transmission or reception of the pre-determined data; reducing the transmission or reception beams of the pre-determined data; transmitting or receiving the pre-determined data with a pre-determined number of beams. In some embodiment, the determined number of beams is one beam. In some embodiment, the determined number of beams is associated with frequency range (for example, FR1, FR2).

The power saving state may include another state wherein the configuration of one or more element is relaxed. In some embodiments, the implementation of relaxing the configuration of the elements includes at least one of the following: reducing the number of active cells, frequency layer, band, carrier, TRP (Transmission and Receive Point), beam, TCI (Transmission Configuration Indication) state, antenna, antenna port, MIMO layer, rank, antenna panel, reference signal, or reference resource; reducing the number of ports of reference signal, or reference resource; configuring the element with a pre-determined number; configuring the element with a pre-determined number of ports; or configuring the cell with pre-determined DRX parameters.

In any embodiment or a combination of two or more embodiment, the power saving state is a relative lower power consumption state. The power saving state is relative to the highest configuration or current configuration of the element. For example, the elements have three states, state1, state2, and state3. Compared with state 1, state 2 and state 3 are both power saving states. Compared with state 2, state 3 is power saving state. Similarly, the non-power saving state is defined relative to the power saving state.

In any embodiment or a combination of two or more embodiment, for the network, when one or more cells are deactivated, or some of the transceiver chains or components are turned off, it can be said that the network is in power saving state. For a cell, when the cell is deactivated, or the common signals and necessary transmissions, such as the SSB, discovery burst, CSI-RS, SRS, positioning RS, SIB1, wake up signal etc., are relaxed, it can be said that the cell is in power saving state. Similarly, when an element is switched to a configuration that can reduce power consumption, for example, when the number of beam is reduced, and/or the number of antenna ports is reduced, and/or the reference signal transmission period is increased, it can be said that the element is switched to the power saving state.

For another item, the information carried by the data and/or reference signal may include a wake-up indication.

In some embodiments, the wake-up indication includes at least one of the following.

The wake-up indication may include that the element is turned on or activated;

The wake-up indication may include that the component of the element is turned on or activated;

The wake-up indication may include that the switching out of an IDLE/Inactive/dormancy state.

In some embodiments, the IDLE state may include at least one of the characteristics: transmit system information (SI) and receive SI request (if configured); transmit DCI scramble with P-RNTI; the DCI can carry short message and/or paging scheduling information; transmit paging message; or transmit synchronization signal block (SSB).

In some embodiments, the inactive state may include at least one of the characteristics: transmit system information (SI) and receive SI request (if configured); transmit DCI scramble with P-RNTI; the DCI can carry short message and/or paging scheduling information; transmit paging message; transmit synchronization signal block (SSB); or store the UE Inactive AS (Access Stratum) context.

In some embodiments, the dormancy state may include at least one of the characteristics: not receive SRS (Sounding Reference Signal); not receive PUSCH (Physical Uplink Shared channel); not receive PRACH (Physical Random Access Control Channel); not transmit the PDCCH (Physical Downlink Control Channel); not receive PUCCH (Physical Uplink Control Channel); or not transmit CSI-RS (Channel State Information reference signal).

The wake-up indication may include that the transmission or reception of a pre-determined reference signal is increased. For example, the pre-determined reference signal includes at least one of SSB, discovery burst, CSI-RS, SRS, positioning RS. In some embodiment, increase the transmission or reception of the pre-determined reference signal includes at least one of the following: increase or trigger the transmission or reception cycle or transmission interval of the pre-determined reference signal; increase or trigger the transmission or reception beams of the pre-determined reference signal; transmitting or receiving the pre-determined reference signal with a pre-determined number of beams; or transmitting or receiving the pre-determined reference signal with a pre-determined cycle, or transmitting or receiving the pre-determined reference signal with an indicated cycle. In some embodiments, the value of the pre-determined number of beams is larger than that when state (mode) transition indication is transmitted.

In some embodiments, the pre-determined cycle includes 20 milliseconds. In this embodiment, the wake-up indication implies transmitting SSB with default cycle, i.e., 20 milliseconds.

In some embodiments, the indicated cycle is associated or indicated by the wake-up indication. For example, the indicated cycle is comprised in the same data packet with wake-up indication. For example, the indication cycle is associated with at least one of the time, frequency, and spatial resource of the wake-up indication.

The wake-up indication may include that the transmission or reception of a pre-determined data is increased. For example, the pre-determined data includes at least one of the system information block (SIB), DCI that schedules SIB, paging message, paging DCI, DCI format 2_7, DCI format 2_6 and broadcast DCI formats. In some example, the system information block includes SIB1. In some embodiment, increasing the transmission or reception of the pre-determined data includes at least one of the following: increase the transmission or reception cycle or transmission interval of the pre-determined data; increase the transmission or reception beams of the pre-determined data; transmitting or receiving the pre-determined data with a pre-determined number of beams. In some embodiment, the determined number of beams is associated with frequency range (FR1, FR2); or transmitting or receiving the pre-determined data with a pre-determined cycle, or transmitting or receiving the pre-determined data with an indicated cycle. In some embodiments, the pre-determined cycle includes 160 milliseconds. In this embodiment, the wake-up indication implies transmitting SIB1 with default cycle, i.e., 160 milliseconds.

In some embodiments, the indicated cycle is associated or indicated by the wake-up indication. For example, the indicated cycle is comprised in the same data packet with wake-up indication. For example, the indication cycle is associated with at least one of the time, frequency, and spatial resource of the wake-up indication.

The wake-up indication may include that the configuration of one or more element is increased. In some embodiments, the implementation of increasing the configuration of the elements includes at least one of the following: increasing the number of active cells, frequency layer, band, carrier, TRP (Transmission and Receive Point), beam, TCI (Transmission Configuration Indication) state, antenna, antenna port, MIMO layer, rank, antenna panel, reference signal, or reference resource; increasing the number of ports of reference signal, or reference resource; increasing the element with a pre-determined number; or increasing the element with a pre-determined number of ports.

For another item, the information carried by the data and/or reference signal may include measurement signal. In some embodiments, the data and/or reference signal sent by UE is used for base station measurement.

In some embodiments, the reference signal sent by UE is used to measure the mobility speed of UE.

In some embodiments, the quality of reference signal sent by UE is used for RRM (radio resource management). In some embodiments, the quality of reference signal is determined by at least one of the RSRP (reference signal received power), RSRQ (reference signal received quality), RSSI (reference signal state information), and SINR (signal-to-noise and interference ratio) of the reference signal.

In some embodiments, the quality of reference signal sent by UE is used for coverage information. In some embodiments, the quality of reference signal is determined by at least one of the RSRP, RSRQ, RSSI, and SINR of the reference signal.

In some embodiments, the quality of reference signal sent by UE is used for channel or interference measurement. In some embodiments, the quality of reference signal is determined by at least one of the L1-RSRP, L1-SINR of the reference signal.

For another item, the information carried by the data and/or reference signal may include measurement results. In some embodiments, the measurement results may be related to at least one of the following: UE Mobility information; RRM (radio resource management); coverage information; and/or channel or channel interference.

For UE Mobility information, the information carried by the data and/or reference signal sent by UE includes mobility information; and/or the information carried by the data and/or reference signal sent by UE is associated with the mobility information.

For RRM (radio resource management), the information carried by the data and/or reference signal sent by UE includes RRM measurement information. For example, the information is related to at least one of the value of RSRP, RSRQ, RSSI, and SINR. The information carried by the data and/or reference signal sent by UE is associated with the RRM measurement information.

For coverage information, the information carried by the data and/or reference signal sent by UE includes coverage information; and/or the information carried by the data and/or reference signal sent by UE is associated with the coverage information.

For channel or channel interference, the information carried by the data and/or reference signal sent by UE includes channel or interference measurement information; and/or the information carried by the data and/or reference signal sent by UE is associated with the channel or interference measurement information.

For another item, the information carried by the data and/or reference signal may include Assistance information.

In some embodiments, the assistance information comprises at least one of the traffic pattern, UE mobility information, UE capability, UE requirement for the delay, the bandwidth UE prefer, the service scenario of UE.

In some embodiments, the information carried by the data and/or reference signal sent by UE includes the assistance information.

In some embodiments, the information carried by the data and/or reference signal sent by UE is associated with the assistance information.

In some embodiments, the information carried by the data and/or reference signal may include a combination of two or more items described above.

In some implementations, the information comprise the state transition indication and UE assistance information. For example, relaxing the transmission of a pre-determined reference signal indication and the UE prefer bandwidth is send by UE.

In some other implementations, the information comprises the wake up indication and measurement information. For example, the wake-up indication and the value of L1-RSRP are send by UE to help the gNB decide how to update/modify the configuration of the elements.

In some other implementations, the information includes the UE assistance information and the measurement information. For example, the mobility information and the maximum delay UE can accept are transmitted to gNB, and the gNB adjusts the most suitable configurations such as the number of antennas and bandwidth according to the received information.

Transmission of Data or/and Reference Signal

The transmission of data or/and reference signal is determined by at least one of the following.

The transmission of data or/and reference signal is based at least one of higher layer signaling, UE capability, SCS, frequency range, etc.

In some embodiments, the transmission of data or/and reference signal is determined by high layer signaling, for example the RRC signaling and/or MAC CE. For example, the data or/and reference signal is transmitted according to the high layer signaling configuration or the high layer signaling triggering.

In some embodiments, the transmission of data or/and reference signal is determined by the UE capability. For example, the data or/and reference signal is transmitted when it is supported by UE capability.

In some embodiments, the transmission of data or/and reference signal is determined by SCS or frequency range. For example, the UE with different SCS or different frequency range has different transmission scheme.

The transmission of data or/and reference signal is based on at least one of a start point, or a periodicity.

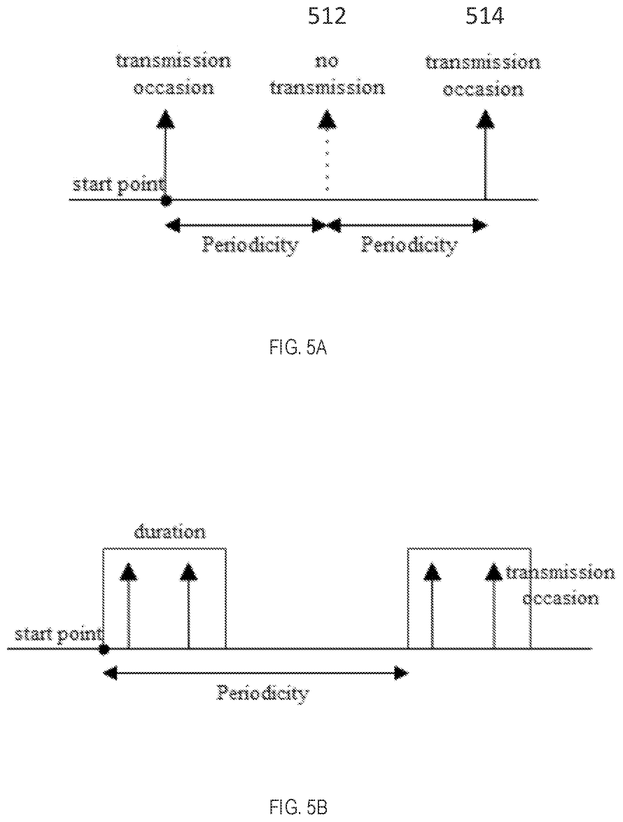

In some embodiments, referring to FIG. 5A, the transmission occasion of data or/and reference signal can be configured by a parameter set which comprise at least one of a start point and a periodicity. The UE transmits data or/and reference signal in the transmission occasion only when the indication is needed. For example, in response to no indication at 512, there is no transmission at 512; and in response to an indication at 514, transmission occurs at 514.

In some embodiments, referring to FIG. 5B, the transmission occasion of data or/and reference signal can be configured by a parameter set which comprise at least one of a start point, a duration and a periodicity. In each duration, there are one or more transmission occasions. The UE transmits data or/and reference signal in the transmission occasion only when the indication is needed. In some embodiments, the duration is determined by a start point and an end point.

At least one of the start point, duration and the periodicity are determined by at least one of the high layer parameters, SCS, UE capability, and frequency range. In some embodiments, at least one of the start point, duration and the periodicity are configured by the high layer parameters. In some embodiments, at least one of the start point, duration and the periodicity are different with different SCS or frequency range.

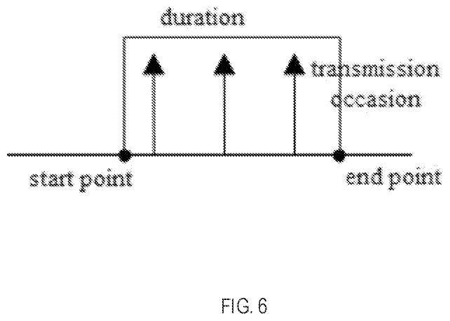

The transmission of data or/and reference signal is based on a first window. In some embodiments, referring to FIG. 6, the first window is determined by at least one of a start position, a duration, end a position. In some embodiments, the start or end position of the first window is defined in relative to at least one of the following: SSB/SSS/PSS, TRS, PO, PEI, DRX ON duration, or DCI format 2_6.

For SSB/SSS/PSS, at least one of the start or end position of the first window are around an SSB. For example, at least one of the start or end position of the first window is located at a distance offset from SSB.

For TRS, the TRS is the connected mode TRS. In some embodiments, the TRS is the connected mode TRS used for IDLE mode UE. For example, at least one of the start or end position of the first window are around a TRS. For example, at least one of the start or end position of the first window is located at a distance offset from TRS.

For PO, at least one of the start or end position of the first window are around a PO. For example, at least one of the start or end position of the first window is located at a distance offset from PO.

For PEI, at least one of the start or end position of the first window are around a PEI. For example, at least one of the start or end position of the first window is located at a distance offset from PEI.

For a DRX ON duration, at least one of the start or end position of the first window are within a DRX ON duration. For example, the start point of the first window is the begin of the DRX ON duration, that is the start of the drx-onDurationTimer.

For DCI format 2_6, at least one of the start or end position of the first window are around a DCI format 2_6. For example, at least one of the start or end position of the first window is located at a distance offset from DCI format 2_6.

The transmission of data or/and reference signal is based on a first predetermined condition. In some embodiments, the first predetermined condition includes at least one of the following: UE preference, data to be transmitted; and/or coverage information.

Regarding UE preference, UE prefers at least one of the following: to accessing to the cell; increased number of elements, wherein the elements comprise at least one of the cell, frequency layer, band, carrier, TRP, beam, TCI state, antenna, antenna port, MIMO layer, rank, antenna panel, reference signal, or reference resource; increased number of ports of the transmission of the pre-determined data or/and reference signals; increased number of beams of the transmission of the pre-determined data or/and reference signals; smaller transmission delay; and/or the data to be transmitted. For example, when the size of the data to be transmitted is larger than or equal to X bits, the data or/and reference signal is transmitted. X is a positive value.

Regarding the data to be transmitted, in some embodiments, the data is uplink data. In some other embodiments, the size of the data to be transmitted satisfies pre-determined conditions. For example, when the size of the data to be transmitted is larger than or equal to X bits, the data or/and reference signal is transmitted. For example, when the size of the data to be transmitted is less than Y bits, the data or/and reference signal is transmitted. X is a positive value. Y is a positive value.

Regarding Coverage information, In some embodiments, when the RSRP is lower than or equal to a pre-determined value, the data or/and reference signal is transmitted. In some embodiments, when the coverage areas not overlapped between different cells, the data or/and reference signal is transmitted.

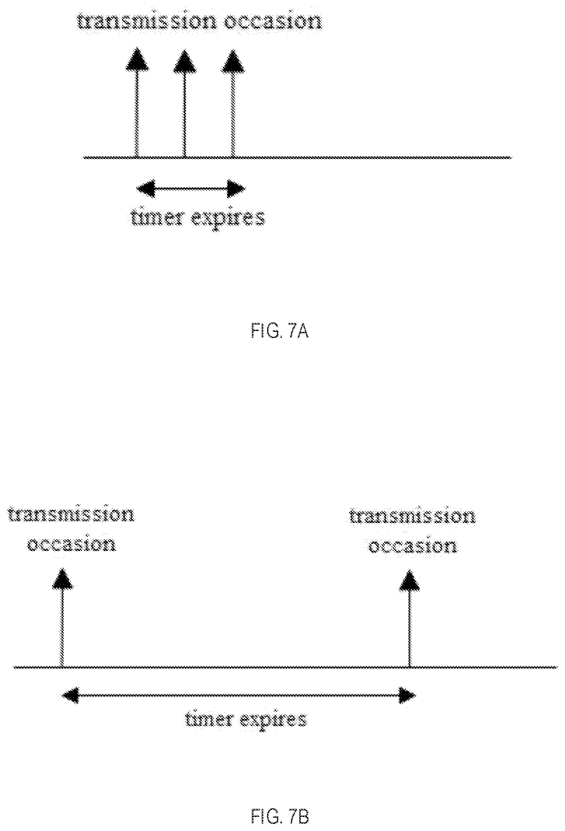

The transmission of data or/and reference signal is based on a timer. In some implementation, referring to FIG. 7A, the timer may be a positive timer, wherein transmission may occur during the timer or before the timer expires. In some other implementation, referring to FIG. 7B, the timer may be a negative timer, wherein transmission may not occur during the timer or before the timer expires.

For a positive timer, the timer is determined by higher layer signaling; and/or the UE may transmit the data/reference signal when the timer is running.

For a negative timer, the timer is a prohibit timer. In some example, the prohibit timer is started after UE transmits the data/reference signal; the UE may transmit the data/reference signal when the timer expires; and/or the UE may transmit the data/reference signal when (1) the timer expires and (2) the transmission times of the data/reference signal does not exceed a maximum transmission times.

The transmission of data or/and reference signal is based on a maximum transmission times. In some embodiments, the transmission times of the data/reference signal does not exceed the maximum transmission times.

The transmission of data or/and reference signal is based on a transmitted times of the reference signal/data. In some embodiments, the transmission resource in time domain of the reference signal/data is associated with the transmitted times of the data/reference. For example, transmission resource in time domain of the reference signal/data transmitted in the first time may not be the same with the transmission resource in time domain of the reference signal/data transmitted in the second time.

### Determination of Frequency Resource of the Reference Signal/Data

Frequency resource of the reference signal/data is determined based on at least one of the following.

The frequency resource of the reference signal/data is determined based on a higher layer signaling/parameters. In some embodiments, the frequency resource of the reference signal/data is configured by high layer signaling/parameters. For example, the high layer signaling/parameters configures the total frequency resource and or the location of the frequency resource of the reference signal and or the data.

The frequency resource of the reference signal/data is determined based on a start/end position in frequency domain. In some embodiments, the start/end position in frequency domain is defined in relative to at least one of the following: common resource block #0; Point A; SSB, for example, reference point is the lowest RB (RE) of the SSB; CORESET 0, for example, reference point is the lowest RB (RE) of the CORESET 0; or active BWP, for example, reference point is the lowest RB (RE) of the active BWP.

The frequency resource of the reference signal/data is determined based on a number of RBs. In some embodiments, the number of RB is determined by a bitmap, or configuration of consecutive RBs.

The frequency resource of the reference signal/data is determined based on an SSB or CORSET 0 or active BWP, or initial UL BWP. For example, UE may not transit the data/reference signal outside the frequency span of the SSB or CORESET or active BWP, or initial UL BWP.

The frequency resource of the reference signal/data is determined based on a transmitted times of the reference signal/data. In some embodiments, the transmission resource in frequency domain of the reference signal/data is associated with the transmitted times of the data/reference. For example, transmission resource in frequency domain of the reference signal/data transmitted in the first time may not be the same with the transmission resource in frequency domain of the reference signal/data transmitted in the second time.

### Determination of Spatial Information of the Data/Reference Signal

The spatial information of the data/reference signal is determined based on at least one of the following: SSB, TRS, PEI, Paging DCI. In some embodiments, the SSB, TRS, PEI, paging DCI is an associated SSB, TRS, PEI, paging DCI. In some embodiments, the TRS is the TRS in connected mode. In some embodiments, the TRS is the connected mode TRS used in idle mode.

In some embodiments, the spatial information of the data/reference signal associated with the beam direction of the pre-determined downlink signal or channel. The pre-determined downlink signal or channel comprises at least one of the following: SSB, TRS, PEI, Paging DCI. In some embodiments, the spatial information of the data/reference signal implicitly indicates the optimal beam direction of the pre-determined downlink signal or channel. For example, the data/reference signal has different transmission resource, and each resource associated with one beam direction of the pre-determined downlink signal or channel. The data/reference signal is transmitted in the resource associated with the optimal beam direction of the pre-determined downlink signal or channel. When the based station received the data/reference signal, it obtains the optimal beam direction of the pre-determined downlink signal or channel.

In some embodiments, the data/reference signal is transmitted with multiple beams or quasi-colocation (QCL) information associated with the pre-determined downlink signal or channel.

Format of Data or/and Reference Signal

In some embodiments, the reference signal includes at least one of the following.

The reference signal may include SRS based signal, and the SRS based signal used for the above indication/functionalities and the legacy SRS is distinguished by at least one of the following: 1. Sequence generation include at least one of cyclic shift, antenna port, sequence initialization. For example, at least one of the sequence generation related factors are different between the SRS based signal used for the above indication/functionalities and the legacy SRS; 2. High layer parameters. In some embodiments, at least one of the SRS based signal related high layer parameters are different from that of the legacy SRS; 3. Time domain resource allocation. For example, the time domain resource allocation are different between the SRS based signal used for the above indication/functionalities and the legacy SRS. The SRS based signal with the first configuration of time domain resource allocation carries the above indication/functionalities. The SRS based signal with the second configuration of time domain resource allocation is used for legacy functionality; and/or 4. Frequency domain resource allocation. For example, the frequency domain resource allocation are different between the SRS based signal used for the above indication/functionalities and the legacy SRS. The SRS based signal with the first configuration of frequency domain resource allocation carries the above indication/functionalities. The SRS based signal with the second configuration of frequency domain resource allocation is used for legacy functionality.

The reference signal may include ZC sequence based signal, and the reference signal is a DMRS based sequence, and its generation method is related to DMRS.

The reference signal may include PRACH preamble based signal, and the PRACH preamble used for the above indication/functionalities and the PRACH preamble used for access is distinguished by at least one of the following: 1. Sequence generation include at least one of Cycling shift, sequence initialization, root sequences. For example, at least one of the sequence generation related factors such as the cycling shift, sequence initialization and root sequences are different between the PRACH preamble based signal used for the above indication/functionalities and the PRACH preamble used for access; 2. Preamble format; 3. Time domain resource allocation. For example, the PRACH preamble based signal with the first configuration of time domain resource allocation carries the above indication/functionalities. The PRACH preamble based signal with the second configuration of time domain resource allocation is used for legacy functionality. The legacy functionality refers to the function of PRACH preamble in Release-15 or Release-16; 4. Frequency domain resource allocation. For example, the PRACH preamble based signal with the first configuration of frequency domain resource allocation carries the above indication/functionalities. The PRACH preamble based signal with the second configuration of frequency domain resource allocation is used for legacy functionality; 5. Pre-determined. In some embodiments, some sequences of the 64 preambles are pre-determined to indicate different meanings; and/or 6. An index. In some embodiments, the index is an index associated with the PRACH preamble, for example the logical root sequence index, the preamble index.

In some embodiments, the data includes at least one of the following.

The data may include a Message A based channel, and the indication is carried by the PRACH preamble in Message A. In some embodiments, the Message A based channel used for the above indication/functionalities and the Message A used for access is distinguished by at least one of the following: 1. Sequence generation of PRACH preamble in Message A include at least one of Cycling shift, sequence initialization, root sequences. For example, at least one of the sequence generation related factors such as the cycling shift, sequence initialization and root sequences are different between the PRACH preamble in Message A used for the above indication/functionalities and the legacy Message A; 2. Preamble format of PRACH preamble in Message A; 3. Time domain resource allocation; 4. Frequency domain resource allocation; 5. Pre-determined. In some embodiments, some sequences of the 64 preambles of PRACH preamble in Message A are pre-determined to indicate different meanings; and/or 6. An index. In some embodiments, the index is an index associated with the PRACH preamble, for example the logical root sequence index, the preamble index

The data may include a PUCCH, and the PUCCH is configured by higher layer signaling. In some embodiments, the PUCCH used for the above indication/functionalities and the PUCCH used for legacy functionalities (for example, the SR, the CSI, ACK/NACK) is distinguished by at least one of the following: the time domain resource allocation; the frequency domain resource allocation; PUCCH format; the generation method, the modulation method or scrambling method; and/or the length of the UCI. In some embodiments, the indication/functionalities are added to the existing PUCCH.

The data may include a PUSCH. In some embodiments, the indication is carried by the PUSCH without dynamic grant. In some other embodiments, the indication is carried by the PUSCH with dynamic grant. In some other embodiments, the indication is carried by the PUSCH in Message A. In some other embodiments, the PUSCH used for the above indication/functionalities and the PUSCH used for legacy transmission is distinguished by at least one of the following: High layer signaling/parameters; and/or Scrambling method.

The data may include a MAC CE. In some embodiments, the data is carried by MAC CE.

In some embodiments, the information carried by the reference signal/data is determined by the at least one of the following (or the functionalities of the reference signal/data is distinguished by at least one of the following): sequence generation include at least one of Cycling shift, sequence initialization; format (for example, preamble format, or sequence VS data); time domain resource allocation of the reference signal/data; frequency domain resource allocation of the reference signal/data; or an ID. In some embodiments, the ID is an ID associated with the reference signal or data. In some embodiments, the ID is a group ID associated with the reference signal or data.

Configuration of Information in the Data or/and Reference Signal

The State (mode) transition for gNB or base station and/or wake-up indication are indicated by one or more bit.

For one example of indication by a single bit, a bit value of ‘A’ for the single bit (Bit ‘A’) may indicate switching to or stay power saving state; and a bit value of ‘B’ for the single bit (Bit ‘B’) may indicate the wake-up indication, which means leave the power saving state or stay in the non-power saving state.

For another example of indication by a single bit, Bit ‘A’ may indicate to change the current state; Bit ‘B’ may indicate to stay in current state. Wherein to change the current state means switching to power saving state if current state is non-power saving state, or wake up/switching to non-power saving state if current state is power saving state.

In some implementations, Bit ‘A’ is “1”, and bit ‘B’ is ‘0’. In some other implementations, bit ‘A’ is ‘0’, and bit ‘B’ is ‘1’.

For one example of indication by n bits, where n>1, using the codepoint indicates different power consumption state, wherein each state corresponding to one configuration or one configuration set of at least one of the elements, it can be a power saving state or a non-power saving state. For example, state 1 with configuration 1, wherein one of the cells is deactivated. State 2 with configuration 2, wherein the reference signal period is M (M is a real number, e.g., M=0.5, M=1) times current configuration. State 3 with configuration 3, wherein at least one of the elements switch to power saving state periodically, and the period of state 3 is a, where a is a positive integer. Other configurations, such as the number of antennas, number of panels, and number of ports, may be configured in different states. The configurations of different elements may be combined into a configuration set, which is corresponding to a state.

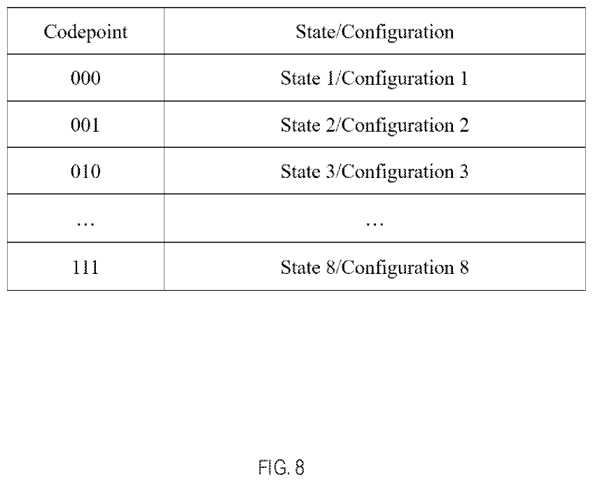

For another example of indication by n bits, where n>1, the n bits may indicate 2\hat{ }n states. Each codepoint corresponding to one state. FIG. 8 shows an example when n=3.

In some implementations when the number of states is less than 2\hat{ }n, the previous codepoints can be used preferentially. For example, when there are only five states, codepoint 000-100 are used, and codepoint 101-111 does not mean anything.

In some other implementations when the state the indication indicates is same as the current state the element stay, the element may keep the current state.

### Resource Collision Between Reference Signal/Data and Other Signal/Channel

In some embodiments, the reference signal/data is transmitted in DL (downlink) symbol only. In some embodiments, the reference signal/data can be transmitted in DL symbol and flexible symbol. In some embodiments, when the reference signal/data collides with the pre-determined signal or channel, the pre-determined signal or channel are transmitted preferentially. The pre-determined signal or channel comprise at least one of SSB, paging DCI, paging message, SIB.

Subsequent Behavior at UE without gNB Response

When there is no response from the base station, the UE does not need to wait for the indication from the base station, the indication sent by UE will be valid after an application delay. In some embodiments, the application delay is determined by at least one of the following.

The application delay may be determined based on higher layer signaling.

The application delay may be determined based on UE capability.

The application delay may be determined based on a frequency range.

The application delay may be determined based on the indication information by the UE. For example, the number of increased elements indicated by UE, or the number of elements determined by UE indication. In some embodiments, a power saving state is indicated or determined by UE indication, the application delay is a first value, a non-power saving state/wake up indication is indicated or determined by UE indication, the application delay is a second value. The first value is larger than the second value.

The application delay may be determined based on a pre-determined value or value set. In some embodiments, a pre-determined value or a pre-determined value set is used to indicate the application delay. The pre-determined can be in the unit of symbols, slots, sub-frames or milliseconds.

The application delay may be determined based on an SCS. In some embodiments, the application delay is determined by the SCS corresponding to the element. In some embodiments, the application delay is determined by the minimum SCS of the UE. In some embodiments, the application delay is determined by the maximum SCS of the UE.

### Other Information on the Base Station Side

A base station (e.g., gNB) may receive the information carried by a data or/and reference signal from the UE; and/or the gNB may perform the state (mode) transition operation according to at least one of the following,

The gNB may perform the state (mode) transition operation according to the network receiving X indication from UE to indicate a state (mode) transition, where X≥1 or X/N≥p. N is the number of UEs in one cell, p≤1, and/or X is the number of UEs in the same power consumption state.

The gNB may perform the state (mode) transition operation according to UE assistance information in the information. At least one of the UE assistance information fulfill at least one of the following condition: the mobility speed of the UE is lower than a threshold; the current service of UE is insensitive to the delay, that is, a large delay can be accepted; the data to be transmitted for the UE in the following periods is small; the UE expects to enter a low power consumption state (e.g., IDLE state, inactive state, dormancy state, and DRX-OFF.); and/or the UE can obtain data/reference signal from other cell.

The gNB may perform the state (mode) transition operation according to a number of UEs (terminals) in one cell. In some embodiments, when the number of UEs in one cell is less than a threshold, the network will hand over the UEs to other cells and perform the state (mode) transition operation.

The gNB may perform the state (mode) transition operation according to a coverage of the cells. In some embodiments, when a cell can cover the areas of other cells (multiple cells can cover the same area), one or more cells with smaller coverage areas can perform the state (mode) transition operation. In some embodiments, when multiple cells can cover the same area, one or more cells with fewer UEs can be switch to the power saving state. In some embodiments, when multiple cells can cover the same area, the base station may determine to deactivate one or more cells with few UEs.

The gNB may perform the state (mode) transition operation according to a configuration of the UEs. In some embodiments, the UEs related to the elements are in power saving state (e.g., IDLE/Inactive state, dormancy state), the elements can switch to power saving state. In some embodiments, the UEs are configured as CA(Carrier Aggregation)/DC(Dual Connectivity), and the UE can obtain the needed information from one of the cells, the elements can switch to power saving state.

The gNB may perform the state (mode) transition operation according to a traffic type currently transmitted. In some embodiments, whether the element can perform the state (mode) transition operation is related to the traffic type currently transmitted. For example, for the services with small data transmission requirement and insensitive to delay, the elements can be switch to power saving state, for example, reduce the antenna/bandwidth/MIMO layer.

The gNB may perform the state (mode) transition operation according to a UE capability.

The gNB may perform the state (mode) transition operation according to at least one of a period, a timer and a duration is configured. The elements switch to power saving state periodically.

The gNB may perform the waking up operation according to at least one of the following.

The gNB receives X indication from UE to indicate the gNB to wake up, where X≥1 or X/N≥p. N is the number of UEs in one cell, p≤1, and/or X is the number of UEs in the same power consumption state.

The gNB may perform the waking up operation according to the gNB receiving the UE assistance information. At least one of the UE assistance fulfill at least one of the following conditions: the mobility speed of the UE is larger than a threshold; the current service of UE is sensitive to the delay, that is, a large delay may not be accepted; the data to be transmitted for the UE in the following periods is large; and/or the UE may not obtain data/reference signal from other cell.

The gNB may perform the waking up operation according to a number of UEs (terminals) in one cell is larger than a threshold, and/or the network will hand over the UEs to other cells and wake up the cell.

The gNB may perform the waking up operation according to a traffic type currently transmitted. For example, for the URLLC service, the requirement of time delay is high, and the gNB should transmit data as fast as possible. Therefore, the corresponding elements should be waked up.

The gNB may perform the waking up operation according to a UE capability.

The gNB may perform the waking up operation according to at least one of a period, a timer and a duration is configured to indicate gNB wake up.

In some embodiments, the base station changes the power state after receive the reference signal and/or data from UE. In some embodiments, after the base station changing the power state according to the reference signal and/or channel from UE, the base station does not change the power state until it receives the reference signal and/or channel from UE again. In some other embodiments, after the base station changing the power state according to the reference signal and/or channel from UE, the base station changes the power state after a duration or the base station changes the power state until a timer expires. In some other embodiments, the base station switch to previous power state after the duration end or timer expires. In some other embodiments, the base station switch to a default power state after the duration end or timer expires. In some embodiments, the default power state is configured by high layer parameters.

The present disclosure describes methods, apparatus, and computer-readable medium for wireless communication. The present disclosure addressed the issues with transmitting and receiving signal for power management. The methods, devices, and computer-readable medium described in the present disclosure may facilitate the performance of wireless communication by transmitting and receiving signal for power management, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a user equipment (UE) to a base station, a reference signal or a channel, wherein the reference signal or the channel is used for measurement or used to carry information,
wherein the information comprises at least one of the following:
an indication which is used to indicate a power state;
a power state transition indication;
a wake-up indication;
a set of measurement results: or
assistance information.

2. (canceled)

3. (canceled)

4. (canceled)

5. The method according to claim 1, wherein the power state comprises a first power state, wherein the first power state comprises at least one of the following:
turning on at least one of elements;
turning on at least one of the components of at least one of elements;
increasing transmission of a given reference signal;
increasing transmission of a pre-determined data;
increasing a configuration of at least one of elements; or
keeping an element on current state.

6. (canceled)

7. (canceled)

8. The method according to claim 5, wherein:
the given reference signal comprises at least one of the following: a synchronization signal block (SSB), a discovery burst, a channel state information reference signal (CSI-RS), a sounding reference signal (SRS), or a positioning reference signal (RS).

9. The method according to claim 5, wherein:
the pre-determined data comprises at least one of the following: a system information block (SIB), a downlink control information (DCI) that schedules a SIB, a paging message, a paging DCI, a DCI format 2_6, a DCI format 2_7 and a broadcast DCI format.

10. (canceled)

11. (canceled)

12. (canceled)

13. The method according to claim 5, wherein:
the increasing transmission of the given reference signal comprises at least one of the following:
increasing a transmission cycle of the reference signal;
increasing a transmission interval of the reference signal;
increasing transmission beams of the reference signal;
transmitting the reference signal with a seventh number of beams; or
transmitting the reference signal with an eighth cycle.

14. (canceled)

15. The method according to claim 5, wherein:
the increasing transmission of the pre-determined data comprises at least one of the following:
increasing a transmission period of the data;
increasing a transmission interval of the data;
increasing transmission beams of the data;
transmitting the data with a eleventh number of beams; or
transmitting the data with a twelfth cycle.

16. (canceled)

17. (canceled)

18. (canceled)

19. The method according to claim 1, wherein:
the transmission of the reference signal or the channel is determined by at least one of the following:
a higher layer configuration;
a UE capability;
a SCS; or
a frequency range.

20. The method according to claim 1, wherein:
the transmission occasion of the reference signal or the channel is determined by at least one of a start point, a duration, an end position, or a periodicity.

21-30. (canceled)

31. The method according to claim 1, wherein:
the reference signal comprising at least one of the following:
a SRS based signal;
a Zadoff-chu (ZC) sequence based signal; or
a physical random access channel (PRACH) preamble based signal.

32. The method according to claim 1, wherein:
the channel comprising at least one of the following:
a Message A based channel;
a physical uplink control channel (PUCCH);
a physical uplink shared channel (PUSCH); or
a medium access control (MAC) control element (CE).

33-36. (canceled)

37. The method according to claim 1, wherein:
an application delay after transmitting the information, the UE determines the information as being valid, wherein the application delay is determined by at least one of the following:
a higher layer signaling;
UE capability;
a frequency range;
indication information by the UE;
a pre-set value; or
a configured value set.

38. A method for wireless communication, comprising.
receiving, by a base station from a user equipment (UE), a reference signal or a channel, wherein the reference signal or the channel is used for measurement or used to carry information,
wherein the information carried by the reference signal or the channel comprises at least one of the following:
an indication which is used to indicate a power state;
a power state transition indication;
a wake-up indication;
a set of measurement results; or
assistance information.

39-47. (canceled)

48. An apparatus comprising:
a memory storing instructions; and
a processor in communication with the memory, wherein, when the processor executes the instructions, the processor is configured to cause the apparatus to perform:
transmitting, to a base station, a reference signal or a channel, wherein the reference signal or the channel is used for measurement or used to carry information,
wherein the information comprises at least one of the following:
an indication which is used to indicate a power state;
a power state transition indication;
a wake-up indication;
a set of measurement results; or
assistance information.

49. The apparatus according to claim 48, wherein the power state comprises a first power state, wherein the first power state comprises at least one of the following:
turning on at least one of elements;
turning on at least one of the components of at least one of elements;
increasing transmission of a given reference signal;
increasing transmission of a pre-determined data;
increasing a configuration of at least one of elements; or
keeping an element on current state.

50. The apparatus according to claim 49, wherein:
the given reference signal comprises at least one of the following: a synchronization signal block (SSB), a discovery burst, a channel state information reference signal (CSI-RS), a sounding reference signal (SRS), or a positioning reference signal (RS).

51. The apparatus according to claim 49, wherein:
the pre-determined data comprises at least one of the following: a system information block (SIB), a downlink control information (DCI) that schedules a SIB, a paging message, a paging DCI, a DCI format 2_6, a DCI format 2_7 and a broadcast DCI format.

52. The apparatus according to claim 48, wherein:
the transmission of the reference signal or the channel is determined by at least one of the following:
a higher layer configuration;
a UE capability;
a SCS; or
a frequency range.

53. The apparatus according to claim 48, wherein:
the transmission occasion of the reference signal or the channel is determined by at least one of a start point, a duration, an end position, or a periodicity.

54. The apparatus according to claim 48, wherein:
the reference signal comprising at least one of the following:
a SRS based signal;
a Zadoff-chu (ZC) sequence based signal; or
a physical random access channel (PRACH) preamble based signal.

55. A wireless communication node comprising:
a memory storing instructions; and
a processor in communication with the memory, wherein, when the processor executes the instructions, the processor is configured to cause the wireless communication node to perform:
receiving, from a user equipment (UE), a reference signal or a channel, wherein the reference signal or the channel is used for measurement or used to carry information,
wherein the information carried by the reference signal or the channel comprises at least one of the following:
an indication which is used to indicate a power state;
a power state transition indication;
a wake-up indication;
a set of measurement results; or
assistance information.
